(19) United States
(12) Patent Application Publication
(10) Pub. No.: US 2006/0195862 A1
(43) Pub. Date: Aug. 31, 2006

(54) Trap/filter verification system and method of use thereof

(76) Inventor: Burak Olcen, Syracuse, NY (US)

Correspondence Address: Schmeiser, Olsen & Watts LLP;Suite 201, 3 Lear Jet Lane, Latham, NY, 12110, US

(21) Appl. No.: 11/068,378

(22) Filed: Feb. 28, 2005

(51) Int. Cl. H04M 1/00; H04H 9/00

(52) U.S. Cl. 725/22; 379/399.01

(57) ABSTRACT

A trap verification system for verifying the existence, proper placement and functionality of a trap on a cable television transmission line is provided, wherein the system comprises a headend configured to transmit a inquiry signal to a particular trap and receive a response signal from the trap, the trap configured to receive the inquiry signal and transmit the response signal containing an identifier code associated with the trap and a transmission line through which the signals are transmitted. The headend determines whether that the trap is present on the line, properly placed or properly functioning and may block service to the line if the trap is not present, not properly placed, or not properly functioning.

### BACKGROUND OF INVENTION

1. Technical Field

This invention relates generally to the field of traps and filters of broadband communications lines. More particularly, this invention provides for a trap and/or filter with an identifier code and a system for verification of proper placement of the trap/filter and a method of use thereof.

2. Related Art

Broadband communications have become an increasingly prevalent form of electromagnetic information exchange. Cable television is one of various types of information exchange available to consumers through broadband communications. Typically, cable television distribution is controlled by the use of taps on the transmission lines. Conventional taps are mounted on telephone poles or located in housings at ground level and are inaccessible to the public. A typical tap has multiple ports that are connected to individual authorized users of the cable service. Additionally, ports of a particular tap that are routed to an unauthorized user have a filter or a trap placed on the line at the port. This trap inhibits the transmission of cable services through that particular port.

An increasing problem arises when unauthorized users circumvent the trap, either by tampering or removing the trap, thereby allowing access to the cable services. This unauthorized use of services results in lost revenue and increased cost to repair or replace the trap. Moreover, conventional systems of detecting unauthorized trap removal or tampering require periodic physical inspection to determine whether the trap that has been removed or tampered.

Accordingly, there is a need in the field of broadband communications such as cable television for an improved cable transmission line trap verification system.

### SUMMARY OF INVENTION

The present invention provides a system for verification of proper trap placement and functionality along a cable transmission line.

A first general aspect of the invention provides a cable transmission line trap verification system comprising a headend, at least one trap comprising an identifier code, an inquiry signal sent from the headend and received at the trap, a response signal sent from the trap and received at the headend, the response signal including the identifier code of the trap and at least one transmission line coupling the headend with the trap, wherein the inquiry signal and the response signal are each transmitted through-the transmission line.

A second general aspect of the invention provides a method for using a cable transmission line trap verification system, the method comprising transmitting an inquiry signal from a headend to a trap; wherein the signal is transmitted through at least one transmission line coupling the headend with the trap, receiving the inquiry signal at the trap and transmitting a response signal from the trap to the headend, wherein the response signal comprises an identifier code of the trap. Moreover, the method comprises receiving and processing the response signal at the headend, verifying the proper placement of the trap according to the identifier code of the trap and blocking service to the transmission line of the trap when the proper placement of the trap is not verified or when no response signal is received at the headend.

A third general aspect of the invention provides a cable transmission line trap verification system comprising a headend configured to transmit an inquiry signal and receive a response signal, at least one trap configured block transmission of service, at least one trap monitor coupled to the at least one trap, the at least one trap monitor configured to receive the inquiry signal and transmit the response signal verifying the proper placement and function of the at least one trap on a portion of the transmission line and at least one transmission line coupling the head end to at least one trap, wherein the inquiry and the response signal are transmitted through the transmission line.

A fourth aspect of the invention provides a cable transmission line trap verification system comprising a headend, a trap and means for identifying the trap and determining the existence, proper placement and proper functionality of the trap.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a perspective view of an embodiment of a trap verification system, in accordance with the present invention;

FIG. 2 depicts a side view of an embodiment of a trap with a trap monitor, in accordance with the present invention;

FIG. 3 depicts a side view of an embodiment of a trap with a MAC/IP circuit, in accordance with the present invention; and

FIG. 4 depicts a flow chart of a method of use of a trap verification system, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

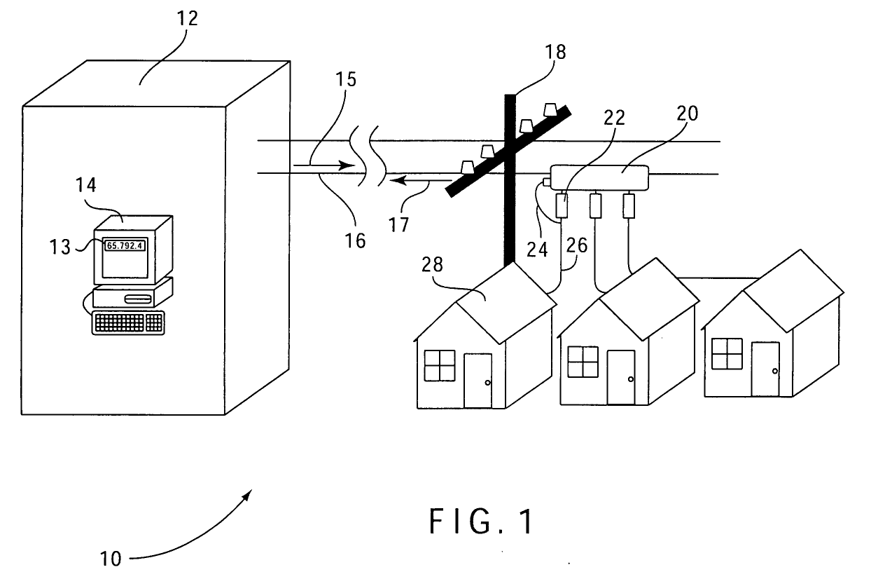

Referring to the drawings, FIG. 1 depicts one embodiment of a trap verification system 10. The system 10 may include a cable headend 12, a computer 14, a transmission line 16, a telephone pole 18, a tap 20 with a plurality of traps 22, a power source 24 for each trap 22, a service line 26 extending from each trap to a corresponding user 28. The computer 14 may comprise a memory and a processor configured to transmit an inquiry signal 15 from the headend 12 to a trap 22 and process a response signal 17 received from the trap 22. The trap 22 may comprise an identifier code 13 that may be unique from other traps 22. The headend 12 may send an inquiry signal 15 through transmission line 16 to a specific trap 22 bearing a unique identifier code 13, which may be specified in the inquiry signal 15. The trap 22 may send a response signal 17 through transmission line 16 to the headend 12. The identifier code 13 for the trap 22 may be included in the response signal 17, whereby the headend 12, by use of computer 14, may process the response signal 17 and determine if the proper identifier code 13 was returned by the trap 22 or if any response signal 17 was transmitted at all. If the correct identifier code 13 is not present in the response signal 17, or if a response signal 17 is not received at the headend 12, the headend 12 may then block service to that particular service line 26, the service block being controlled and facilitated from the headend 12. It should be appreciated by those of ordinary skill that the inquiry signal 15 may be transmitted by use of a forward path frequency spectrum and any other type of path such that the inquiry signal 15 may communicate information from the headend 12 to the trap 22. Also, the response signal may be transmitted by use of a return path frequency and any other type of path and frequency such that the response signal may communicate information from the trap 22 to the headend 12.

The headend 12 will be recognized by those of ordinary skill in the art to be centralized location, whereby to facilitate the transmission of service to particular cable service lines and authorized users. It will further be appreciated that the headend 12 further facilitates the use of a trap verification system 10 from a single location, such as, but not limited to cable service provider headquarters, regional cable service provider offices, other local types of offices managed, owned, or operated by a cable service provider, and any other type of structure that may be configured to retain a device that may comprise a processor and memory which is configured to send an inquiry signal 15 and receive and process a response signal 17 containing an identifier code 13, thereby verifying the existence, proper placement and proper functionality of a trap 22.

With further reference to FIG. 1, the identifier code 13 is shown for the exemplary purposes of this disclosure as a string of numbers or an address associated with a particular trap 22 and is not limited to such a type of identifier code. it should be recognized by those of ordinary skill that the identifer code may be an IP address, such as those for a cable modem or network card on a computer network, an alpha address associated with the location of the trap 22, an alpha-numeric identifier associated with the location of the trap or any other form of unique identifying characteristic where in the identifying characteristic may be transmitted in the inquiry signal 15 and the response signal 17.

Referring further to FIG. 1, the power source 24 may be used to power the trap 22. It should be recognized by those of ordinary skill in the art that the power source 24 is not limited to a power line extending from the transmission line or the trap, but may be any source of power, such as, but not limited to, a battery or external source. Additionally, while FIG. 1 depicts the use of a telephone pole 18 that supports the transmission line 16, the telephone pole 18 should not be viewed by those of ordinary skill to be a limiting element of the present invention. Transmission line 16 may be underground, positioned at ground level or any other location so as to provide service to a plurality of users 28. Also, the tap 20 and the plurality of traps 22 may be configured to correspond to the location of the transmission line 16. The service line 26 may provide access for the user 28 to the transmission line 16 through the tap 20. The trap 24 may function to block service through service line 26.

In particular embodiments, the trap 22 may be placed on the service line 26 and may block all channels to the user 28 connected to the service line 26. Trap verification system 10 may be adapted to determine the existence, proper placement and proper functionality of the trap 22. Accordingly, it may be determined at the headend 12 whether the entire trap 22 has been circumvented allowing an unauthorized user access to all channels provided by the cable service provider. Additionally, other particular embodiments may be adapted to verify existence, proper placement and proper functionality of a trap 22 for filtering of a particular channel provided by the cable service provider, thereby allowing limited viewing of cable channels by an authorized user 28 as determined by an agreement between the user 28 and the cable service provider. Accordingly, the headend 12 would send and inquiry signal 15 to the trap 22 for filtering a particular channel, wherein the inquiry signal contains information that may include the identifier code 13 of the trap 22. The trap may send a response signal 17 that may comprise the identifier code 13 of the trap. The headend 12 may then process and the signal and verify the existence, proper placement and proper functionality of the trap 22.

Those skilled in the art should appreciate that a trap 22 may comprise a plurality traps/filters for filtering a portion of channels that may be transmitted through service line 26 to user 28, whereby the trap verification system 10 may be adapted to account for a trap 22 comprising a plurality of traps/filters. Such adaptation may include, but is not limited to having a unique identifier code 13 for each of the plurality of traps, having a unique identifier code for the trap 22 with additional identifiers associated with each of the plurality of traps and any other form of identifying that the trap 22 comprising a plurality of traps/filters exists, is proper placed and is properly functioning.

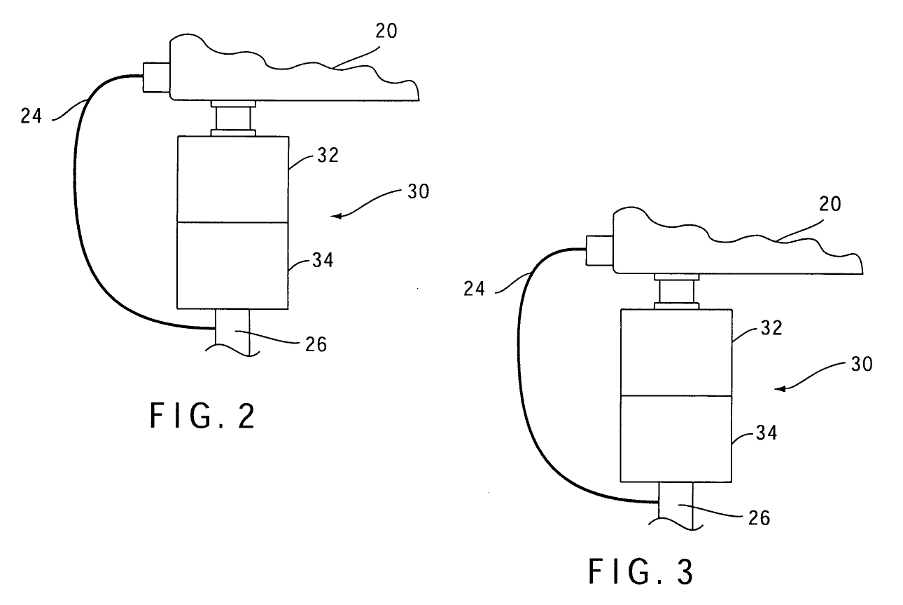

With additional reference to the drawings, FIG. 2 depicts a side view of an embodiment of a trap 30 having a trap monitor 32 and a filter 34. The trap 30 may be coupled to the tap 20 at the trap monitor 32 and coupled to the service line 26 at the filter 34. Power source 24 may provide the necessary power to the trap 30 in order for the trap to properly function. In particular embodiments of the present invention, the trap monitor 32 may receive a general inquiry signal 15 from the headend 12 that is transmitted down a particular transmission line 16, wherein the signal is not directed at a particular trap 30, but all traps 30 present on the particular line. The trap monitor 32 may then transmit a response signal through transmission line 16 to the headend 12. The headend 12 may process the response signal and determine if all traps 30 on the particular line 16 are present. If a trap 30 is determined to not be on the line, the location of the trap 30 on the transmission line 16 may be easily located in order to fix or replace the trap 30 that did not transmit a response signal. Moreover, the determination of a missing trap may assist in a headend-initiated blockage of service to the service line 26 associated with the missing trap 30. It should be recognized by those of ordinary skill that the trap monitor 32 may continuously or periodically transmit a signal verifying that it is present on the line without receiving an inquiry signal 15.

With further reference to the drawings, FIG. 3 depicts a side view of an embodiment of a trap 40 having a MAC/IP circuit 42 and a filter 44. The trap 40 may be coupled to the tap 20 at the MAC/IP circuit 42 and coupled to the service line 26 at the filter 44. Power source 24 may provide the necessary power to the trap 40 in order for the trap 40 to properly function. In particular embodiments of the present invention, the MAC/IP circuit 42 may receive a specific inquiry signal 15 from the headend 12 that may be transmitted down a particular transmission line 16, wherein the signal may be directed at a particular trap 40. The MAC/IP circuit 42 may transmit a response signal 17 through transmission line 16 to the headend 12, thereby transmitting an identifier code 13 associated with that particular trap 40. The headend 12 may process the response signal 17 and determine if trap 40 is on the particular line and properly placed and functioning. If a trap 40 is determined to not be present on the line, determined to be not properly placed on the line or determined to be not functioning properly, the headend 12 may then block service to the particular trap 40 associated with the trap 40 of a particular identifier code 13 that was not returned to the headend 12.

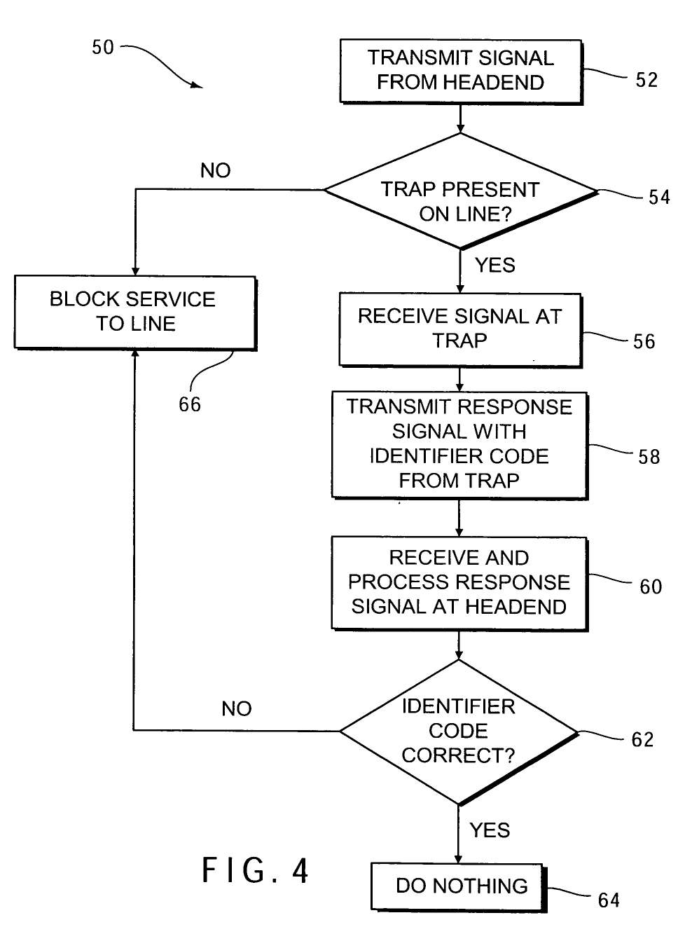

With continued reference to the drawings, FIG. 4 depicts a flow chart of a method of use for a trap verification system. The method 50 may be accomplished by transmitting an inquiry signal from the headend (Step 52). A determination may be made as to whether a trap is present in the line (Step 54). If a trap is not present, then the headend may block service to the line (Step 66). If a trap is present on the line, the next step may be to receive the signal at the trap (Step 56) and then transmit a response signal with an identifier code from the trap (Step 58). The headend may receive and process the response signal (Step 60) and make a determination as to whether the identifier code is correct (Step 62). If the identifier code is not correct, then the headend may block service to the line (Step 66). If the identifier code is correct, then the headend may do nothing (Step 64). Those skilled in the art should appreciate that method 50 may be repeated periodically or regularly during a second, a minute, an hour, a day, a week, a month or any time period determined at the headend 12. Additionally, the method 50 may be accomplished through an automated process or manually effectuated, which may require manual input at the headend 12.

Those of ordinary skill in the art should recognize that there may be various ways of determining the existence, proper placement and proper functionality of the trap 22, and that such determinations may result in the blockage of service. For example, and without limitation, the determining of the existence, proper placement and proper functionality of the trap 22 may include a non-return of the response signal 17, a return of the response signal without an identifier code 13, a return of the response signal 17 with an incorrect identifier code 13, a return of the response signal 17 with a partial identifier code 13, a increase or decrease in time between transmission of an inquiry signal 15 and reception of response signal 17 at the headend 12, the amplification of the response signal 17, a combination thereof and any other form of communicating the existence, proper placement and proper functionality of the trap 22 with the headend 12 such that the control of the service to each service line 26 may be accomplished at the headend 12.

It should be understood by those of ordinary skill in the art that the inquiry signal 15 and the response signal 17 of FIG. 1 and in Steps 52 and 58, may include, but is not limited to a pinging, an SCTE signal, an IEEE signal, a CableLabs signal, an electrical signal, a proprietary signal and any combination thereof, so long as the headend 12 may produce an inquiry signal 15 to a trap 22 and the trap 22 may produce a response signal 17 to the headend 12. It will also be understood that the steps and determinations of method 50 were shown in the order depicted in FIG. 4 as an exemplary method according to an embodiment of the invention, and are not limited to any particular order. Accordingly, the steps of method 50 may be performed in any order, so long as verification of the existence, proper placement and proper functionality of the trap is accomplished.

In particular embodiments of the present invention and with reference to FIGS. 1-4 the means for identifying a trap 22 may be associating a unique identifier code 13 with the trap 22. However, it should be appreciated by those skilled in the art that the means for identifying the trap 22 may include a trap monitor with a particular identifier that monitors the trap, a MAC/IP circuit 42 that assigns a particular address to the trap 22, other forms of electrical identification wherein the identifier code 13 or address may be, but is not limited to a numeric code, an alpha code, an alphanumeric code, a binary code, a hexadecimal code, and any combination thereof.

Further, in particular embodiments of the present invention, the means for determining the existence, proper placement and proper functionality of the trap 22 may be sending an inquiry signal 15 from the headend 12 to the trap 22. The trap 22 may receive the inquiry signal 15 and transmit a response signal 17, wherein at least on of the inquiry signal 15 and the response signal 17 comprise the identifier code 13. The headend 12 may then receive and process the response signal 17 and determine the existence, proper placement and proper functionality of the trap 22. If the response signal 17 is received with the proper identifier code 13, the trap 22 is determined to be in existence, proper placement and proper functionality. However, it will be recognized by those of ordinary skill in the art that the determination may be made in other ways, such as, but not limited to, a non-return of the response signal 17, a return of the response signal without an identifier code 13, a return of the response signal 17 with an incorrect identifier code 13, a return of the response signal 17 with a partial identifier code 13, a increase or decrease in time between transmission of an inquiry signal 15 and reception of response signal 17 at the headend 12, the amplification of the response signal 17, a combination thereof and any other form of communicating the existence, proper placement and proper functionality of the trap 22 with the headend 12 such that the control of the service to each service line 26 may be accomplished at the headend 12. Additionally, the inquiry signal 15 and the response signal 17 may include a pinging, an SCTE signal, an IEEE signal, a CableLabs signal, an electrical signal, a proprietary signal and any combination thereof.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A cable transmission line trap verification system comprising:
a headend;
at least one trap comprising an identifier code;
an inquiry signal sent from the headend and received at the trap; and
a response signal sent from the trap and received at the headend, the response signal including the identifier code of the trap.

2. The system of claim 1, wherein the headend further comprises a memory and a processor for sending the inquiry signal and receiving and processing the response signal.

3. The system of claim 1, wherein the inquiry signal and response signal comprises at least one of a pinging, an SCTE signal, an IEEE signal, a CableLabs signal, an electrical signal, a proprietary signal and any combination thereof.

4. The system of claim 2; wherein the headend is configured to determine the existence, proper placement and proper functionality of the at least one trap.

5. The system of claim 4, wherein the headend is further configured to block service to a line when the at least one trap is determined to not exist, does not have the proper placement on the line or is not properly functioning.

6. The system of claim 5, wherein the at least one trap comprises a plurality of traps.

7. The system of claim 6, wherein the plurality of traps comprises a MAC/IP circuit that generates the identifier code, wherein the identifier code comprises a unique address.

8. A method for using a cable transmission line trap verification system, the method comprising:
transmitting an inquiry signal from a headend to a trap;
receiving the inquiry signal at the trap;
transmitting a response signal from the trap to the headend, wherein the response signal comprises an identifier code of the trap;
receiving and processing the response signal at the headend;
verifying the existence, proper placement and proper functionality of the trap according to the identifier code of the trap; and
blocking service to the transmission line of the trap when the existence, proper placement or proper functionality of the trap is not verified or when no response signal is received at the headend.

9. The method of claim 8, wherein transmitting the inquiry signal from the headend to the trap, receiving the inquiry signal at the trap, transmitting a response signal from the trap to the headend and receiving and processing the response signal at the headend further comprises inquiry and response signals of at least one of a pinging, an SCTE signal, an IEEE signal, a CableLabs signal, an electrical signal, a proprietary signal and any combination thereof.

10. The method of claim 8, wherein the identifier code of the trap comprises a unique address of the trap.

11. The method of claim 8, wherein in transmitting the inquiry signal from the headend to the trap further comprises transmitting a plurality of signals from the headend to a corresponding plurality of traps.

12. The method of claim 11, wherein receiving the inquiry signal at the trap further comprises receiving a plurality of signals at a plurality of traps, wherein each signal is received by a different trap.

13. The method of claim 12, wherein transmitting the response signal from the trap to the headend further comprises transmitting a plurality of response signals each signal transmitted from one of the plurality of traps to the headend.

14. The method of claim 13, wherein receiving and processing the response signal at the headend further comprises receiving and processing the plurality of response signals at the headend.

15. The method of claim 14, wherein verifying the proper placement of the trap according to the identifier code of the trap further comprises verifying the proper placement of the plurality of traps according to the identifier code of each of the plurality of traps.

16. The method of 15, wherein blocking service to the transmission line of the trap when the existence, proper placement or proper functionality of the trap is not verified or when no response signal is received at the headend further comprises blocking service to particular transmission lines corresponding to particular traps of the plurality of traps wherein the proper placement of particular traps of the plurality of traps is not verified or when no response signal from particular traps is received at the headend.

17. A cable transmission line trap verification system comprising:
a headend configured to transmit an inquiry signal and receive a response signal;
at least one trap configured block transmission of service; and
at least one trap monitor coupled to the at least one trap, the at least one trap monitor configured to receive the inquiry signal and transmit the response signal, wherein the response signal verifies the existence, proper placement, and proper functionality of the at least one trap.

18. The system of claim 17, wherein the inquiry signal and the response signal comprises at least one of a pinging, an SCTE signal, an IEEE signal, a CableLabs signal, an electrical signal, a proprietary signal and any combination thereof.

19. The system of claim 17, wherein the headend is further configured to block transmission of service to the portion of the transmission line corresponding to the at least one trap determined to not exist, does not have the proper placement on the line or is not functioning properly.

20. A cable transmission line trap verification system comprising:
a headend;
a trap; and
means for identifying the trap and determining the existence, proper placement and proper functionality of the trap.
